(19) United States
(12) Patent Application Publication
(10) Pub. No.: US 2011/0133377 A1
(43) Pub. Date: Jun. 9, 2011

(54) Plate spring

(76) Inventor: Yury Ivanovich Ermilov, Moscow (RU)

(21) Appl. No.: 12/663,806

(22) PCT Filed: May 16, 2008
(86) PCT No.: PCT/RU08/00306

§ 371 Date: Feb. 16, 2011

(30) Foreign Application Priority Data
Jun. 22, 2007 (RU) 2007123351

(51) Int. Cl. F16F 3/00; F16F 1/18

(52) U.S. Cl. 267/158

(57) ABSTRACT

The invention relates to mechanical engineering, in particular to spring elements for compliant foil hydrodynamic bearings used in small-size high speed machines. The inventive spring is cut out from a single sheet and comprises a plurality of elementary arc-shaped springs (2, 3). Said springs (2, 3) are arranged in series. The long springs 2 have an equal length between the supporting edges. The short springs 3 also have an equal length. The elementary springs (2, 3) are interconnected by means of narrow elements (8). The difference in the length of the springs (2, 3) makes it possible to achieve variable bearings stiffness. The variable width of the springs (2) and/or the variable width of the springs (3) makes it possible to achieve variable plate springs stiffness in the direction of the elementary springs.

### TECHNICAL FIELD

Invention is related to machinery in particular spring elements of compliant foil hydrodynamic bearings which is used in small-size high speed machines such as turboexpanders, turbocompressors and others.

### BACKGROUND ART

The known plate spring is used in the foil hydrodynamic radial bearing (U.S. Pat. No. 5,427,455), it comprises plurality of elementary springs (cantilever beams) of equal length between their supporting edges, the sidelong edges of said springs are interconnected by means of narrow elements. Plurality of said plate springs are arranged on inner cylindrical surface of the bearing case along its axis and said plate springs are joined into the common block so called the spring foil. This plate springs receive radial load from the rotor journal.

The said plate spring has an disadvantage: about constant stiffness in wide bearing load span while in order to reduce bearing wear during start-stop cycles and keep high bearing load capacity at nominal rotation speed it is necessary small plate spring stiffness under small load and big plate spring stiffness under big load.

The said plate spring has another disadvantage: constant stiffness of the plate spring along the bearing axis while there is necessity to create variable stiffness of the plate spring along the bearing axis under the rotor cantilever radial loads.

### SUMMARY OF INVENTION

The object of the present invention is to provide variable stiffness of the plate spring from load and to provide variable stiffness of said plate spring in the direction of elementary springs arrangement.

The appointed object is achieved by the following way. The plate spring comprises plurality of elementary springs. Sidelong edges of said springs are interconnected by means of narrow elements. Plurality of elementary springs comprises several parts. Each of said parts includes only elementary springs of equal length. Said springs from said different parts have different lengths. Elementary springs of said plurality interchange so that they form two or more groups comprising elementary springs of different length.

### BRIEF DESCRIPTION OF THE DRAWINGS

FIG. 1 is a perspective, schematic view of the plate spring.

FIG. 2 is a schematic plan view of the plate spring.

FIG. 3 is a schematic plan view of the plate spring with elementary springs of three different lengths.

FIG. 4 is schematic plan view of the spring foil.

FIG. 5 is a perspective view of the spring foil arrangement in the foil hydrodynamic radial bearing.

FIGS. 6 and 7 show cross sectional views of the foil radial bearing with the plate spring under small bearing load.

FIG. 8 shows cross sectional view of the foil radial bearing with the plate spring under big bearing load.

FIGS. 9 and 10 depict bearing load as a function of journal radial deflection.

### DESCRIPTION OF EMBODIMENTS

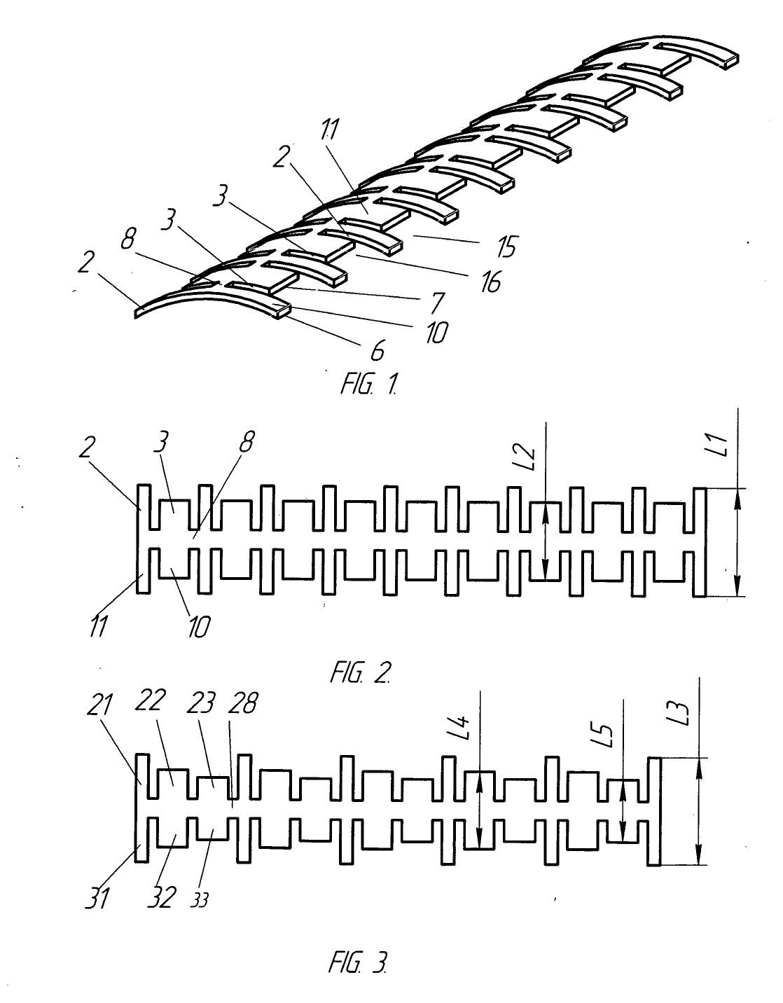

The plate spring is shown in FIG. 1.

The plate spring cut of one thin sheet comprises plurality of elementary arch-shaped springs 2 and 3. Sidelong edges of said springs 2 and 3 are interconnected by means of narrow elements 8.

Surfaces 10 and 11 of springs 2 and 3 can belong to the common cylindrical surface of the plate spring with generatrix 15 and arch-shaped directive 16.

FIG. 2 illustrates the said plate spring in plan view. Plurality of all elementary springs comprises two parts. One part of said plurality comprises long elementary springs 2 of length L₁ each. Another part comprises short elementary springs 3 of length L₂ each. Elementary springs interchange so that they form groups comprising two springs. Each group comprises springs 2 and 3.

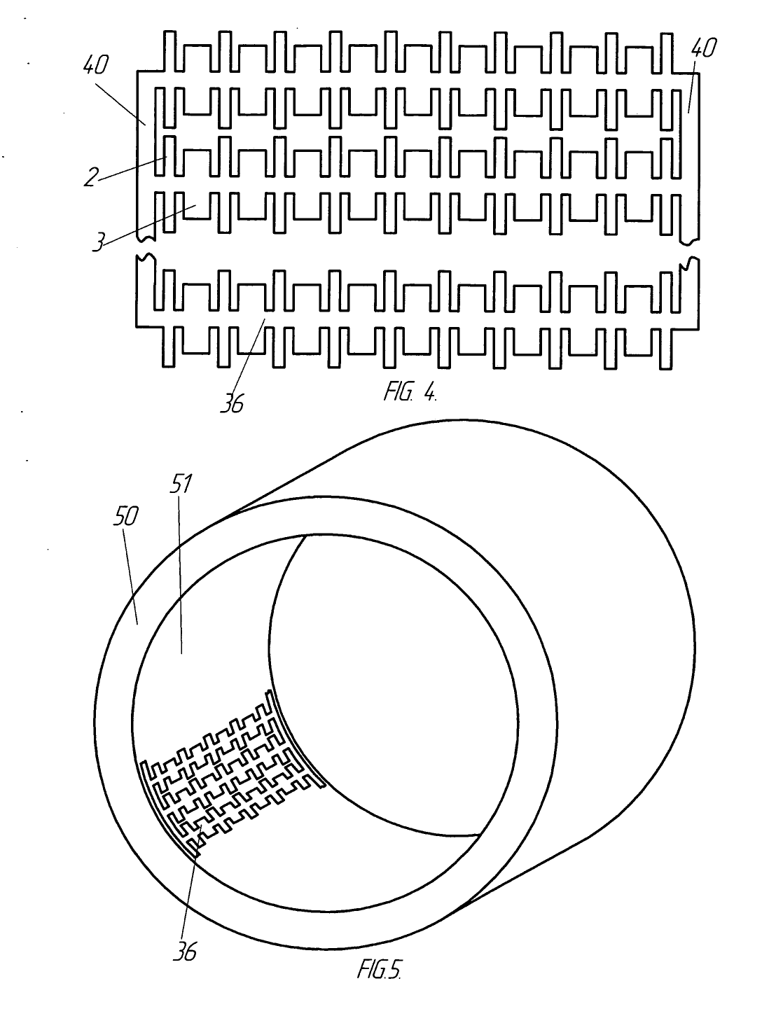

FIG. 3 illustrates another embodiment of the plate spring. Plurality of all elementary springs comprises elementary arch-shaped springs 21, 22 and 23. Sidelong edges of said springs 21, 22 and 23 are interconnected by means of narrow elements 28. The length of all springs 21 is L₃. The length of all springs 22 is L₄. The length of all springs 23 is L₅. Elementary springs interchange so that they form groups comprising three springs. Each group comprises springs 21, 22 and 23.

Cylindrical surfaces 31, 32, 33 of the elementary springs 21, 22, 23 can belong to the common cylindrical surface of the plate spring.

Spring block comprising several plate springs or so called the spring foil is used for convenient assembling foil radial bearings.

FIG. 4 illustrates the variant of such a spring foil. Spring foil 36 is made of one thin sheet and comprises several plate springs that are shown in FIGS. 1 and 2. Plate springs are joined by sidelong bridges 40.

FIG. 5 illustrates arrangement of the spring foil 36 in the foil radial bearing. Said plate springs are arranged along bearing axis. There is not shown the journal inside the foil radial bearing and top foil also called the fluid foil disposed between the spring foil 36 and the journal. The spring foil is arranged on the inner surface 51 of the bearing case 50. The spring foil is fixed on the case 50 by welding or in any possible way. Several such spring foils can be arranged on the inner surface 51 of the bearing case in the circumferential direction.

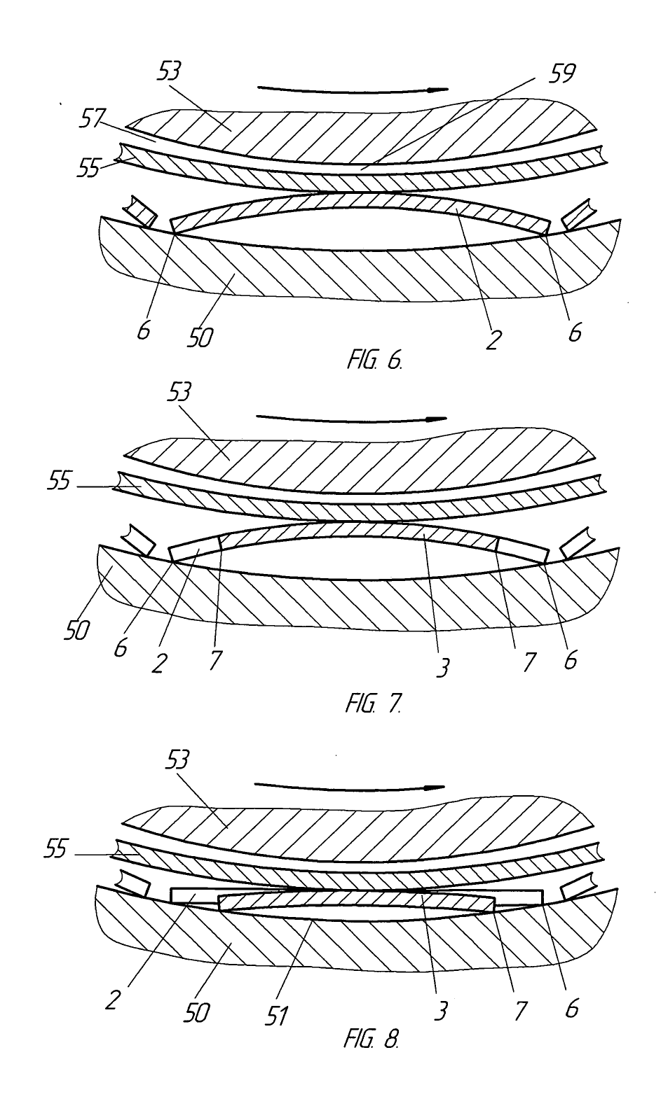

FIGS. 6 and 7 illustrate cross sectional views of the radial foil hydrodynamic bearing under bearing load equal to about rotor weight.

The radial foil hydrodynamic bearing operates in the following way. Rotating journal surface drags surrounding air from zone 57 where there is big air layer thickness into zone 59 where there is small air layer thickness. The pressure in the air layer increases at diminishing air layer thickness. At some rotation speed the value of pressure becomes sufficient to prevent contact between the journal 53 and the top foil 55 surfaces. Surface of the top foil 55 faced the journal is the contact bearing surface. Rotation speed increasing causes enlarging the air layer thickness in zone 59 and bearing load capacity.

The load passes from the journal to the top foil 55. Part of the load is passed from top foil to the plate spring shown in FIGS. 6 and 7. The load from the said plate spring to the bearing case 50 is passed only through supporting edges 6 of long elementary springs 2. Springs 3 don't touch the bearing case. Stiffness of the said plate spring is equal to the summary stiffness of long elementary springs 2 and it is pretty small. Said summary stiffness is as small as adjacent plate springs stiffness. Thereby bearing stiffness is also small.

At start and stop processes (when rotation speed is small) dry friction between the journal surface 53 and the surface of top foil 55 takes place. Due to small initial stiffness of the foil radial bearing, a more number of plate springs receive load from journal that enlarges the contact surface area, reduces contact pressure on the top foil and diminishes the top foil wear at rotor start/stop.

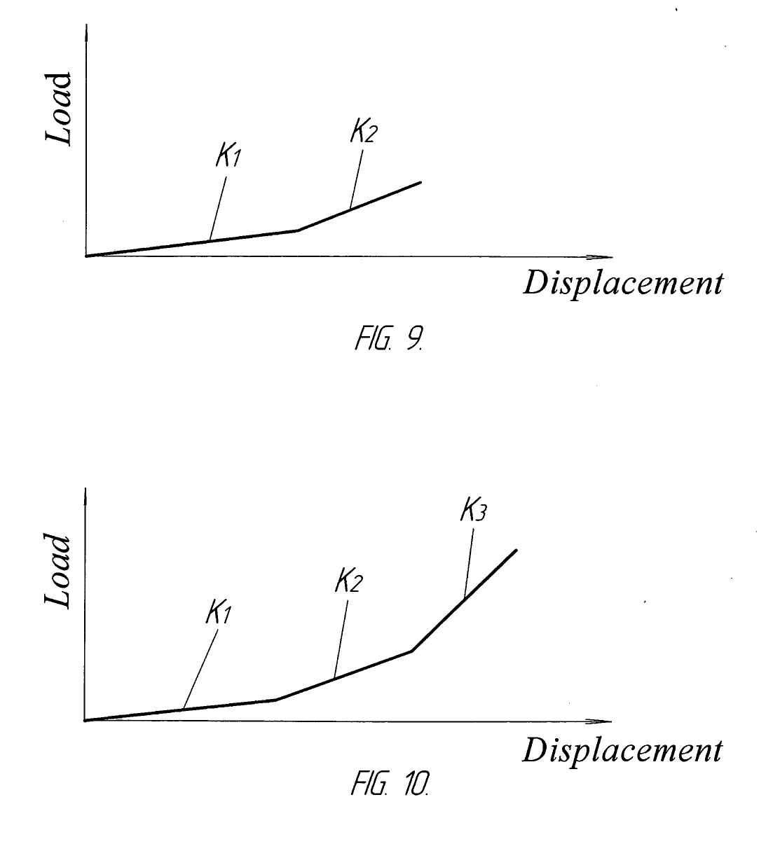

At enlarging bearing load the plate spring deflection increases and achieves such a value that supporting edges 7 of short elementary springs 3 begin to contact with the bearing case inner surface 51 that is illustrated in FIG. 8. In this case the plate spring stiffness is equal to the summary stiffness of long and short elementary springs 2 and 3. Because the length of short spring 3 is less and its width is more than the width of long spring 2, the short spring stiffness is more than the long spring stiffness. That is why the radial foil bearing stiffness greatly increases after the contact between the supporting edges 7 of short springs 3 and the bearing case surface.

Dependence of bearing load from radial rotor journal displacement for the radial foil hydrodynamic bearing with plate springs comprising elementary springs 2 and 3 is shown in FIG. 9. The bearing stiffness coefficient K1 under small displacement is much less than bearing stiffness coefficient K2 under big displacement. Interchanging springs of different length 2 and 3 allows equably distributing load on the top foil 55 in the direction of the plate spring arrangement.

Under very big bearing load, necessity in additional increasing bearing stiffness may arise. The plate spring shown in FIG. 3 can be used in this case. Under very big bearing load, supporting edges of shortest elementary springs 23 begin to contact with the bearing case inner surface and bearing stiffness increases achieving maximum value.

Dependence of bearing load from radial rotor journal displacement for the radial foil bearing with plate springs comprising elementary springs 21, 22 and 23 is shown in FIG. 10. The more the radial rotor journal displacement increases the more the bearing stiffness coefficient increases, taking values K₁, K₂ and K₃.

Rotors of some high speed machines revolve in nominal regime under big radial cantilever load. Under said load, deformation and reaction of elementary springs 2 and 3 (FIG. 8) increase and air layer thickness reduces along bearing axis to the cantilever rotor part. Such change in air layer thickness reduces bearing load capacity. Minimal change in air layer thickness leads to increasing bearing load capacity and it is achieved by decreasing the plate springs stiffness along bearing axis to the cantilever rotor part. Such decrease in stiffness is achieved by diminishing width of short springs 3 in the said direction. Long elementary springs 2 have equal width and stiffness to supply the small top foil wear at start/stop.

Besides using the presented plate spring in radial hydrodynamic foil bearings, it can be used as spring element that receives load from the rotor in axial hydrodynamic foil bearings.

I claim:

1. The plate spring comprising:
plurality of elementary springs whose sidelong edges are interconnected by narrow elements;
said plurality of elementary springs consisting of several parts;
each of said parts including only elementary springs of equal length;
said springs of said different parts having different lengths;
elementary springs of said plurality interchanging so to form two or more groups comprising elementary springs of different length.

2. The plate spring according to claim 1 wherein said elementary springs have arch forms.

3. The plate spring according to claim 2 wherein said elementary springs have cylinder surfaces with common generatrix and common directive.

4. The plate spring according to claim 2 wherein said elementary springs of different length have different width.

5. The plate spring according to claim 2 wherein said elementary springs of equal length have equal width.

6. The plate spring according to claim 2 wherein said elementary springs of equal length have different width.
